(19) United States
(12) Patent Application Publication
(10) Pub. No.: US 2026/0012914 A1
(43) Pub. Date: Jan. 8, 2026

(54) SYSTEM, METHOD AND PROGRAM FOR ESTIMATING POSITION OF APPARATUS, BASE STATION, RELAY APPARATUS, AND, SYSTEM, METHOD AND PROGRAM FOR WIRELESS POWER TRANSFER

(71) Applicant: SoftBank Corp., Tokyo (JP)

(72) Inventors: Naoki Hasegawa, Tokyo (JP); Takashi Hirakawa, Tokyo (JP); Yuta Nakamoto, Tokyo (JP); Yoshichika Ota, Tokyo (JP)

(73) Assignee: SoftBank Corp., Tokyo (JP)

(21) Appl. No.: 18/846,354

(22) PCT Filed: Feb. 14, 2023
(86) PCT No.: PCT/JP2023/004949

§ 371 Date: May 23, 2025

(30) Foreign Application Priority Data
Mar. 31, 2022 (JP) 2022-059107

(51) Int. Cl. H04W 64/00; H04W 4/80; H04W 88/04

(52) U.S. Cl. CPC H04W 64/00; H04W 4/80; H04W 88/04

(57) ABSTRACT

Provided is a method capable of accurately estimating a position of a target apparatus for wireless power transfer, etc. Near-field radio waves are received from a relay apparatus positioned in an area between the base station and a target apparatus by plural antenna elements of an antenna apparatus of a base station, for each of the plural antenna elements, an angle of a direction of the relay apparatus with respect to a position of the antenna element is calculated based on a reception result of radio waves from the relay apparatus, and a position of the relay apparatus is estimated based on a calculation result of the angle of each of the plural antenna elements and position information on the antenna element in the antenna apparatus.

### TECHNICAL FIELD

The present invention relates to a system, a method and a program for estimating a position of an apparatus, a base station, a relay apparatus, and, a system, a method and a program for wireless power transfer.

### BACKGROUND ART

There is conventionally known a communication system that performs communications between a base station (communication relay apparatus) and a terminal apparatus using at least some of plural radio resources that are set in a radio frame (for example, see Patent Literature 1).

### CITATION LIST

### Patent Literature

Patent Literature 1: International Publication No. 2017/164220.

### SUMMARY OF INVENTION

### Technical Problem

In a conventional communication system, as a terminal apparatus that connects and communicates with a communication relay apparatus such as a base station or a wireless-LAN access point apparatus, etc., there is a portable-type terminal apparatus that mainly uses electrical power supplied from a built-in battery. In this terminal apparatus, it is necessary to perform a cumbersome task of charging the built-in battery when the remaining capacity of the built-in battery becomes low. Furthermore, a terminal apparatus that uses electrical power supplied from a wired-connection power line rather than the built-in battery is limited to use in a location where such a power line is available. Thus, a power supply infrastructure capable of supplying electrical power to various terminal apparatuses that connect and communicate with a communication relay apparatus such as a base station, etc. has not yet been developed.

In the fifth generation and subsequent next generation communication systems, the number of terminal apparatuses (for example, user apparatuses, IoT devices, etc.) that connect and communicate with a communication relay apparatus such as a base station and wireless-LAN access point apparatus, etc. is expected to increase rapidly, and a development of communication infrastructure to handle a huge amount of traffic is underway. However, a power supply infrastructure capable of supplying electrical power to the huge number of terminal apparatuses that perform the foregoing communications remains underdeveloped. In particular, it becomes a problem to efficiently supply power to each of the plural terminal apparatuses.

### Solution to Problem

A method according to an aspect of the present invention is a method for estimating a position of an apparatus. This method includes receiving near-field radio waves from a relay apparatus positioned in an area between a base station and a target apparatus by plural antenna elements of an antenna apparatus of the base station, calculating, for each of the plural antenna elements, an angle of a direction of the relay apparatus with respect to a position of the antenna element based on a reception result of the radio waves from the relay apparatus, and estimating a position of the relay apparatus based on a calculation result of the angle of each of the plural antenna elements and position information on the antenna element in the antenna apparatus.

In the foregoing method, the method may include receiving the radio waves from the target apparatus by plural relay apparatuses whose positions are estimated, calculating, for each of the plural relay apparatuses, angle information on the direction of the target apparatus or distance information on the target apparatus with respect to the position of the relay apparatus based on a reception result of the radio waves from the target apparatus, and estimating the position of the target apparatus based on a calculation result of the angle information or the distance information on each of the plural relay apparatuses and position information on each of the plural relay apparatuses.

A wireless-power transfer method according to another aspect of the present invention includes forming a beam toward the target apparatus based on the estimation result of the position of the relay apparatus and the estimation result of the position of the target apparatus estimated by the foregoing method, and transmitting an electrical power to the target apparatus via the beam, by the base station.

In the foregoing wireless-power transfer method, the method may include determining a tilt angle of the beam toward the target apparatus based on the estimation result of the position of the relay apparatus and the estimation result of the position of the target apparatus.

A system according to yet another aspect of the present invention is a system that comprises a base station connected to a communication network. This system comprises a relay apparatus positioned in an area between the base station and a target apparatus. The base station receives near-field radio waves from the relay apparatus by plural antenna elements of an antenna apparatus, calculates, for each of the plural antenna elements, an angle of a direction of the relay apparatus with respect to a position of the antenna element based on a reception result of the radio waves from the relay apparatus, and estimates a position of the relay apparatus based on a calculation result of the angle of each of the plural antenna elements and position information on the antenna element in the antenna apparatus.

In the foregoing system, the system may comprise plural relay apparatuses, each of the plural relay apparatuses may receive the radio waves from the target apparatus, calculate angle information on the direction of the target apparatus or distance information on the target apparatus with respect to the position of the relay apparatus based on a reception result of the radio waves from the target apparatus, and transmit a calculation result of the angle information or the distance information to the base station, and the base station may estimate the position of the target apparatus based on the calculation result of the angle information or the distance information on each of the plural relay apparatuses and position information on each of the plural relay apparatuses.

In the foregoing system, the system may comprise plural relay apparatuses, each of the plural relay apparatuses may receive the radio waves from the target apparatus, and transmit a reception result of the radio waves from the target apparatus to the base station, and the base station may calculate, for each of the plural relay apparatuses, angle information on the direction of the target apparatus or distance information on the target apparatus with respect to a position of the relay apparatus based on a reception result of the radio waves from the target apparatus, and estimate a position of the target apparatus based on the calculation result of the angle information or the distance information on each of the plural relay apparatuses and position information on each of the plural relay apparatuses.

In the foregoing system, the base station may form a beam toward the target apparatus based on the estimation results of the positions of the plural relay apparatuses and the estimation result of the position of the target apparatus, and wirelessly transmit an electrical power to the target apparatus via the beam.

In the foregoing system, the base station may determine a tilt angle of the beam toward the target apparatus based on the estimation results of the positions of the relay apparatuses and the estimation result of the position of the target apparatus.

A base station according to yet another aspect of the present invention comprises means for receiving near-field radio waves from the relay apparatus by plural antenna elements of the antenna apparatus, means for calculating, for each of the plural antenna elements, an angle of a direction of the relay apparatus with respect to a position of the antenna element based on a reception result of the radio waves from the relay apparatus, and means for estimating a position of the relay apparatus based on a calculation result of the angle of each of the plural antenna elements and position information on the antenna element in the antenna apparatus.

In the foregoing base station, the base station may comprise means for forming a beam toward the target apparatus based on the estimation results of the positions of the plural relay apparatuses and the estimation result of the position of the target apparatus, and wirelessly transmitting an electrical power to the target apparatus via the beam.

In the foregoing base station, the base station may comprise means for determining a tilt angle of the beam toward the target apparatus based on the estimation results of the positions of the relay apparatuses and the estimation result of the position of the target apparatus.

The foregoing base station may be a base station of a mobile communication system that has a wireless-power transfer function to the target apparatus.

In the foregoing base station, the antenna apparatus may be an array antenna in which plural antenna elements are disposed two-dimensionally or three-dimensionally.

In the foregoing base station, the antenna apparatus may have antenna elements for position measurement, which are spaced apart from each other and used estimating the position of the relay apparatus.

A relay apparatus according to yet another aspect of the present invention comprises means for receiving the radio waves from the target apparatus, means for calculating angle information on a direction of the target apparatus or distance information on the target apparatus with respect to a position of the relay apparatus based on a reception result of the radio waves from the target apparatus, and means for transmitting a calculation result of the angle information or the distance information to the base station.

A relay apparatus according to yet another aspect of the present invention comprises means for receiving the radio waves from the target apparatus, and means for transmitting a reception result of the radio waves from the target apparatus to the base station.

The foregoing relay apparatus may be a terminal apparatus of a mobile communication system or an access point apparatus.

A program according to yet another aspect of the present invention is a program executed by a computer or processor provided in the foregoing base station. This program includes a program code for receiving near-field radio waves from the relay apparatus by plural antenna elements of the antenna apparatus, a program code for calculating, for each of the plural antenna elements, an angle of a direction of the relay apparatus with respect to a position of the antenna element based on a reception result of the radio waves from the relay apparatus, and a program code for estimating a position of the relay apparatus based on a calculation result of the angle of each of the plural antenna elements and position information on the antenna element in the antenna apparatus.

A program according to yet another aspect of the present invention is a program executed by a computer or processor provided in the foregoing relay apparatus. This program includes a program code for receiving the radio waves from the target apparatus, a program code for calculating angle information on a direction of the target apparatus or distance information on the target apparatus with respect to a position of the relay apparatus based on a reception result of the radio waves from the target apparatus, and a program code for transmitting a calculation result of the angle information or the distance information to the base station.

A program according to yet another aspect of the present invention is a program executed by a computer or processor provided in the foregoing relay apparatus. This program includes a program code for receiving the radio waves from the target apparatus, and a program code for transmitting a reception result of the radio waves from the target apparatus to the base station.

A program used to estimate the position of the foregoing relay apparatus or the foregoing target apparatus may be a learned model created by machine learning.

### Advantageous Effects of Invention

According to the present invention, by the cooperation between the base station connected to the communication network and the relay apparatus that relays wireless communications with a target apparatus, it is possible to estimate a position of the target apparatus with high accuracy.

### BRIEF DESCRIPTION OF DRAWINGS

FIG. 1 is an illustration showing an example of a schematic configuration of a system according to an embodiment.

FIG. 2 is an illustration showing an example of an arrangement of a base station, a relay apparatus and a target apparatus that configure the system according to the embodiment.

FIG. 3 is an illustration showing an example of an overview of a method for estimating each position of the relay apparatus and the target apparatus in the system according to the embodiment.

FIG. 4 is an illustration showing an example of a position estimation of the relay apparatus using a near field.

FIG. 5A is an illustration showing an example of an antenna apparatus of the base station according to the embodiment.

FIG. 5B is an illustration showing an example of an antenna apparatus of the base station according to the embodiment.

FIG. 5C is an illustration showing an example of an antenna apparatus of the base station according to the embodiment.

FIG. 5D is an illustration showing an example of an antenna apparatus of the base station according to the embodiment.

FIG. 6A is an illustration showing an example of a position estimation of the relay apparatus using the near field.

FIG. 6B is an illustration showing an example of a position estimation of the relay apparatus using the near field.

FIG. 7 is an illustration showing an example of a position estimation of the target apparatus via plural relay apparatuses in the system according to the embodiment.

FIG. 8 is an illustration showing another example of a position estimation of the target apparatus via plural relay apparatuses in the system according to the embodiment.

FIG. 9 is an illustration showing an example of an estimation model expressed using a complex vector used for the position estimation of the target apparatus in the system according to the embodiment.

FIG. 10 is an illustration showing an example of estimation of unknown quantities Ds1 and Ds2 in the estimation model of FIG. 9.

FIG. 11 is an illustration showing an example of definition of coordinates and planes in the position estimation of the target apparatus in a three-dimensional space.

FIG. 12 is an illustration showing an example of a position estimation of the target apparatus in the three-dimensional space.

### DESCRIPTION OF EMBODIMENTS

Hereinafter, embodiments of the present invention are described with reference to the drawings.

A system according to an embodiment described herein is a system capable of estimating a position of a target apparatus with high accuracy, by cooperating between a base station having a function as a wireless-power transfer apparatus for wireless power transfer (WPT) which is connected to a mobile communication network and a relay apparatus (for example, fixed-access point apparatus, mobile-communication terminal equipment (UE), master repeater) that relays wireless communications with the target apparatus (for example, IoT device, slave repeater). In the system of the present embodiment, an electrical power can be efficiently supplied from the base station to the target apparatus by directing a beam for wireless power transfer (hereinafter also referred to as “WPT beam”) to the target apparatus whose position is estimated.

It is noted that, in the following embodiments, although a case is described in which a mobile-communication base station also serves as a wireless-power transfer apparatus to configure a wireless-power transfer (WPT) system, the wireless-power transfer (WPT) system may be configured so that a wireless-power transfer apparatus is provided separately from the mobile-communication base station is connected to the mobile communication network and an electrical power is supplied from the wireless-power transfer apparatus to a terminal apparatus. The system of the embodiment may be configured as a positioning system or a communication system which has a mobile-communication base station.

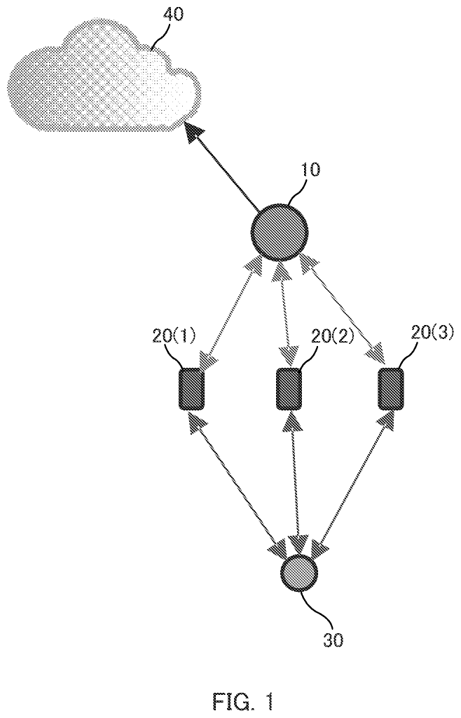

FIG. 1 is an illustration showing an example of a schematic configuration of a system according to the present embodiment. The system of the present embodiment is provided with a cellular base station 10 forming a communication area (cell) 10A and single or plural relay apparatuses 20. The system according to the present embodiment may be further provided with a target apparatus 30 that is capable of connecting to the base station 10 and wirelessly communicating with the base station 10 when locating in the communication area 10A.

The base station 10 is, for example, a base station (for example, eNodeB, gNodeB) that complies with the standards of mobile communication systems such as the 5th generation, etc. operated in the current mobile communications, or the standards of a mobile communication system of the later generations (for example, B5G (Beyond 5G) or 6G). The base station 10 may have a function as a wireless-power transfer apparatus of WPT.

The relay apparatus 20 has a first communication function for wirelessly communicating with the base station 10 by a first-wireless communication method, and a second communication function for wirelessly communicating with the target apparatus 30 by a second-wireless communication method. The relay apparatus 20 is, for example, an access point apparatus of a wireless connection (for example, a wireless LAN connection) that is fixedly placed in or near the communication area (cell) 10A, or a terminal equipment (UE) such as a smartphone, etc. as a mobile station for mobile communication that has a function as a master repeater for the target apparatus (slave repeater) 30.

It is noted that, although the system in the example of FIG. 1 and the figures described below has three relay apparatuses 20(1) to 20(3), the number of relay apparatuses 20 may be one or two, or may be four or more. When distinguishing the plural relay apparatuses from each other, an identification number is attached for each relay apparatus as in the case of the relay apparatuses 20(1) to 20(3), and when explaining a single relay apparatus or matters common to the plural relay apparatuses, the explanation is made without attaching identification numbers.

The target apparatus 30 is, for example, a terminal apparatus (also referred to as “UE” (user equipment)) as a mobile station of a mobile communication system. The target apparatus 30 may be a combination of a communication apparatus (for example, a mobile communication module) capable of performing a wireless communication with the base station 10 and various kinds of devices. The target apparatus 30 may be an IoT device connectable to the Internet via the base station 10.

The target apparatus 30 has a function of wirelessly communicating with the base station 10 as well as a function of wirelessly communicating with the relay apparatus 20 using the second-wireless communication method described above. Further, the target apparatus 30 may have a function as a wireless-power reception apparatus of the wireless power transfer (WPT).

The first-wireless communication method between the relay apparatus 20 and the base station 10 is, for example, a wireless communication method that complies with the standards of mobile communication systems such as the 5th generation, etc. operated in the current mobile communications, or the standards of mobile communication systems of the later generations (for example, B5G (Beyond 5G) or 6G).

The second-wireless communication method between the relay apparatus 20 and the target apparatus 30 is, for example, a BLE (Bluetooth (registered trademark) low energy) communication method or a communication method using UWB (Ultra Wide Band) radio waves as a wireless medium. The UWB is a communication technology using feeble radio waves in a wide band (for example, a bandwidth of several hundred MHz centered on an arbitrary frequency in the several GHz band), and is defined by the IEEE 802.15.4.

The wireless medium of wireless power transfer (WPT) for supplying an electrical power to the target apparatus 30 is, for example, a radio wave of microwave or millimeter wave.

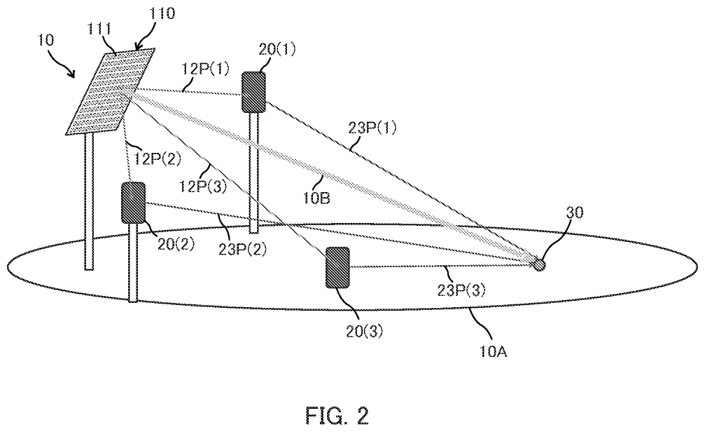

FIG. 2 is an illustration showing an example of an arrangement of the base station 10, relay apparatus 20 and target apparatus 30 that configure the system according to the present embodiment. In FIG. 2, the base station 10 is provided with an array antenna 110 as an antenna apparatus capable of mainly using for the wireless power transfer (WPT). The array antenna 110 is an antenna (rectenna array) with a large aperture (for example, size of several 10 cm×several 10 cm) having plural antenna elements 111 disposed two-dimensionally or three-dimensionally. When performing a wireless power transfer (WPT), the transmission power of each of the plural antenna elements 111 of the array antenna 110 is, for example, several 100 μW to several 10 mW.

The array antenna 110 may also be used as an antenna apparatus for performing a massive MIMO (mMIMO) transmission method communication with plural UEs 20 via radio waves of microwave or millimeter wave.

All or part of the communication area 10A of the base station 10 is a wireless power transfer area (hereinafter referred to as “WPT area”) where an electrical power can be supplied via a focused beam 10B formed by beamforming from the base station 10 toward the target apparatus 30. In the case that the radio waves for power supply, which are transmitted toward the target apparatus 30 positioned approximately 10 m away from the base station 10, are millimeter waves, an electric field in the WPT area is not a far field but a near field.

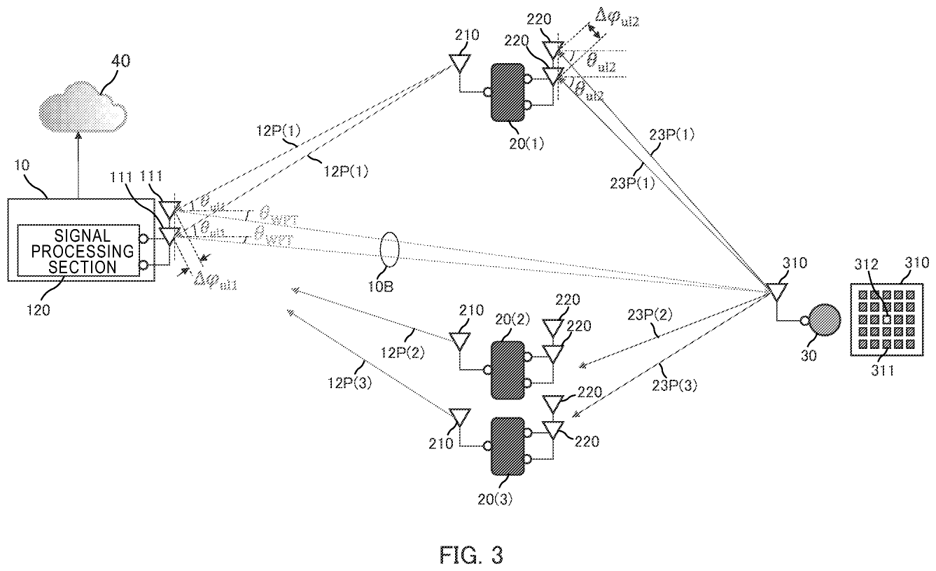

The target apparatus 30 may be provided with an array antenna 310 as an antenna apparatus capable of mainly using for the wireless power transfer (WPT) (see FIG. 3 described below). The array antenna 310 of the target apparatus 30 is, for example, a feeble rectenna array having plural antenna elements 311 of about 100 elements or less that are disposed two-dimensionally or three-dimensionally. Some of the plural antenna elements may be antenna elements 312 for position measurement. When performing the wireless power transfer (WPT), a reception power of each of the plural antenna elements of the array antenna is, for example, several 10 μW to several 100 μW. In this case, the target apparatus 30, which is positioned a predetermined distance (for example, about 10 m) away from the base station 10, can receive an electrical power of, for example, 1 mW or more as a whole of the array antenna of the target apparatus 30.

In FIG. 2, at the positions where communication is possible between the base station 10 and the target apparatus 30 by a predetermined wireless communication method in each of line-of-sight environments (LOS environments), fixed-type access point (AP) apparatuses 20(1), 20(2) and a terminal apparatus (UE) 20(3) that is a mobile station for mobile communication and is capable of moving with a user, vehicle, etc. are disposed as plural relay apparatuses. The relay apparatus 20(3), which is configured with the terminal equipment (UE), functions as a master repeater that relays a communication between the base station 10 and the target apparatus (slave repeater) 30.

The base station 10 can transmit and receive radio waves to and from each of the plural relay apparatuses 20(1) to 20(3) via paths 12P(1) to 12P(3) in the line-of-sight environment (LOS environment). Further, each of the plural relay apparatuses 20(1) to 20(3) can transmit and receive radio waves to and from the target apparatus 30 via the paths 23P(1) to 23P(3) in the line-of-sight environment (LOS environment).

In the present embodiment, as shown below, the position of the target apparatus 30 is estimated via the base station 10 and the plural relay apparatuses 20(1) to 20(3) connected to the mobile communication network, and a tilt angle (θ_{WPT}) of the WPT beam 10B from the base station 10 to the target apparatus 30 is determined based on a result of the estimation.

FIG. 3 is an illustration showing an example of an overview of a method for estimating each position of the relay apparatus 20 and the target apparatus 30 in the system according to the present embodiment. The example in FIG. 3 is an example in the case of estimating the positions (direction θ, distance D) of the relay apparatus 20 and the target apparatus 30 using an angle-of-arrival (AoA) detection of radio waves.

When performing a position measurement for the relay apparatus 20 in FIG. 3, radio waves of a predetermined frequency, which are transmitted from the first antennas 210 of each of the plural relay apparatuses 20(1) to 20(3), are received by the plural antenna elements 111 of the base station 10 via the paths 12P(1) to 12P(3) in the LOS environment. A phase difference Δφ of the radio waves received by the plural antenna elements 111 of the base station 10 is calculated based on a reception result of the radio waves, and the position (direction θ and distance D) of each of the relay apparatuses 20(1) to 20(3) with respect to the position of the base station 10 can be calculated and estimated based on the calculated phase difference Δφ and information on a positional relationship between the plural antenna elements. The calculation of the phase difference Δφ and the calculation of the positions (direction θ and distance D) of the relay apparatuses 20(1) to 20(3) are performed and stored in a signal processing section 120 of the base station 10, and are used for determining the tilt angle (θ_{WPT}) of the WPT beam 10B. Information on the positions (direction θ and distance D) of the relay apparatuses 20(1) to 20(3) may be uploaded to a cloud service system 40 via the mobile communication network.

It is noted that the calculation of the phase difference Δφ and the calculation of the positions (direction θ and distance D) of the relay apparatuses 20(1) to 20(3) may be performed by the cloud service system 40, and the calculation results may be downloaded by the base station 10 and used for determining the tilt angle (θ_{WPT}) of the WPT beam 10B.

When performing a position measurement for the target apparatus 30 in FIG. 3, radio waves of a predetermined frequency, which are transmitted from the target apparatus 30, are received by plural second antennas 220 of each of the plural relay apparatuses 20(1) to 20(3) via the paths 23P(1) to 23P(3) in the LOS environment. A phase difference Δφ of the radio waves received by the plural second antennas 220 of each of the plural relay apparatuses 20(1) to 20(3) is calculated based on a reception result of the radio waves, and the position (direction θ and distance D) of the target apparatus 30 can be calculated and estimated with respect to the position of each of the plural relay apparatuses 20(1) to 20(3) based on the calculated phase difference Δφ and information on the positional relationship between the plural antenna elements. The calculation of the phase difference Δφ and the calculation of the position (direction θ and distance D) of the target apparatus 30 are performed by each relay apparatus 20(1) to 20(3), the calculation results are transmitted to the base station 10 and stored, and are used for determining the tilt angle (θ_{WPT}) of the WPT beam 10B. Information on the position (direction θ and distance D) of the target apparatus 30 may be uploaded to the cloud service system 40 via the mobile communication network.

It is noted that the calculation of the phase difference Δφ and the calculation of the position (direction θ and distance D) of the target apparatus 30 may be performed by the cloud service system 40, and the calculation results may be downloaded by the base station 10 and used for determining the tilt angle (θ_{WPT}) of the WPT beam 10B.

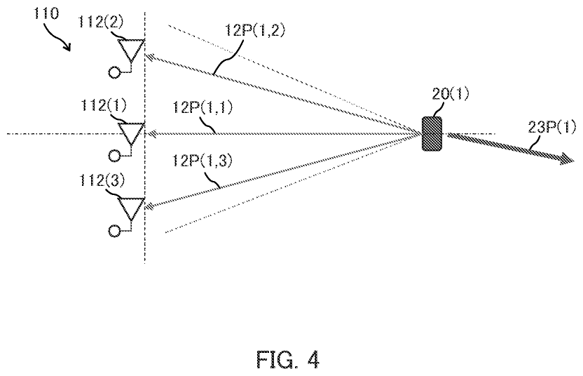

FIG. 4 is an illustration showing an example of a position estimation of the relay apparatus (AP apparatus or master repeater) 20 using the near field. The example in FIG. 4 is an example in the case of estimating the position of the relay apparatus 20(1) using antenna elements 112(1) to 112(3) for position measurement that are respectively disposed at three locations apart from each other on the antenna apparatus 110 of the base station 10. Each of the antenna elements 112(1) to 112(3) for position measurement may be configured with a single antenna element, or may be configured with two or more plural antenna elements. In FIG. 4, the position of the relay apparatus 20(1) with respect to the position of the base station 10 can be calculated and estimated based on the lengths (distances) of the plural paths 12P(1,1), 12P(1,2), 12P(1,3) between each of the three antenna elements 112(1) to 112(3) and the relay apparatus 20(1).

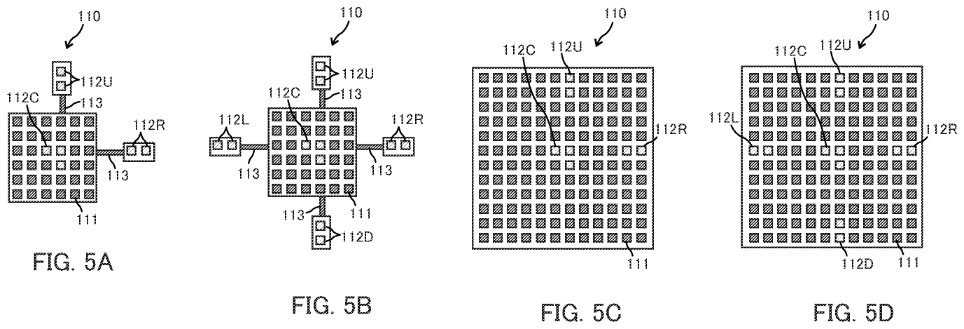

Each of FIGS. 5A to 5D is an illustration showing an example of the antenna apparatus 110 of the base station 10 according to the present embodiment. In the position estimation method of the relay apparatus (AP apparatus or master repeater) 20 exemplified in FIG. 4 described above, since the accuracy of position estimation of the relay apparatus 20 increases as the interval between the plural antenna elements 112 for position measurement becomes larger, the plural antenna elements 112 for position measurement may be disposed apart from each other as shown in FIGS. 5A to 5D.

In FIG. 5A, as the plural antenna elements for position measurement, the example is provided with three antenna elements 112C positioned at the center part of the plural antenna elements 110 of the main body of the antenna apparatus 110, two antenna elements 112U disposed upper the main body via an arm member 113, and two antenna elements 112R disposed on the right side of the main body via the arm member 113.

In FIG. 5B, as the plural antenna elements for position measurement, the example is provided with two antenna elements 112D disposed below the main body via the arm member 113, and two antenna elements 112L disposed on the left side of the main body via the arm member 113, in addition to the three antenna elements 112C at the center part, the two upper antenna elements 112U and the two right side antenna elements 112R described above.

In FIG. 5C, as the plural antenna elements for position measurement, the example is provided with three antenna elements 112C positioned at the center part, two antenna elements 112U positioned at the upper part, and two antenna elements 112R positioned at the right part, among the plural antenna elements 110 of the main body of the antenna apparatus 110.

In FIG. 5D, as the plural antenna elements for position measurement, the example is provided with two antenna elements 112L positioned at the lower part and two antenna elements 112L positioned at the left part, in addition to the three antenna elements 112C at the center part, the two antenna elements 112U at the upper part and the two antenna elements 112R at the right part.

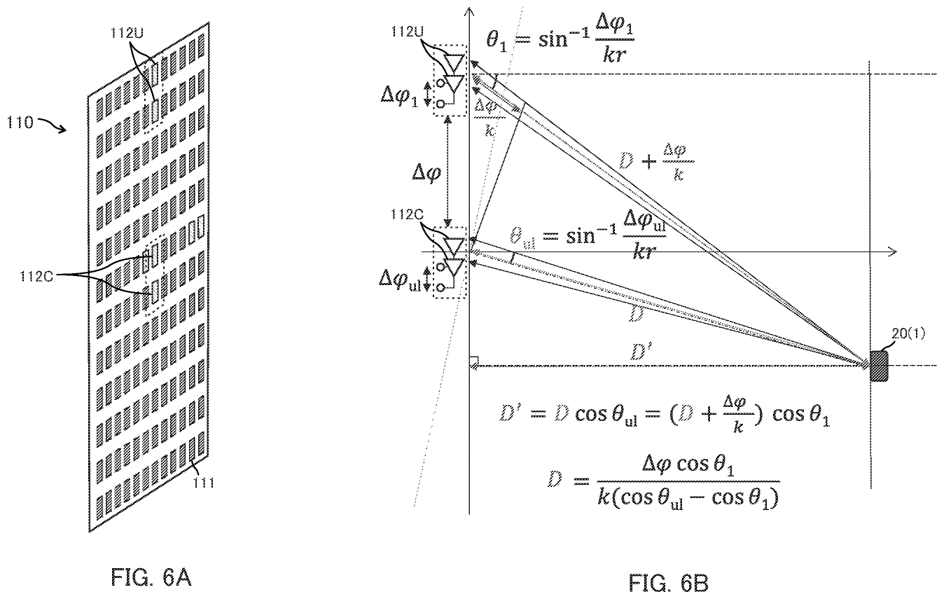

FIGS. 6A and 6B are illustrations showing an example of position estimation of the relay apparatus 20 using the near field. FIG. 6A is a perspective view of the antenna apparatus 110 showing a positional relationship between the antenna element 112C at the center part and the antenna element 112U at the upper part used in the position estimation example of the relay apparatus 20. FIG. 6B is an illustration showing an example of a model used for position estimation of the relay apparatus 20. In the example of FIG. 6, using a near-field region in which the size of the antenna apparatus 110 of the base station 10 cannot be ignored, the position (direction θ, distance D) of the relay apparatus 20(1) viewed from the center of the antenna apparatus 110 of the base station 10 is estimated based on the an inter-antenna-element phase difference between the antenna element 112C at the center part and the antenna element 112U at the upper part.

In FIG. 6A, the direction θᵤₗ of the relay apparatus 20(1) viewed from the antenna element 112C at the center part is expressed by the following equation (1). Herein, Δφᵤₗ is the reception phase difference between the two antenna elements of the antenna element 112C at the center part, k is the wavenumber of radio waves, and r is the spacing between the antenna elements.

$${θ}_{u l} = {sin}^{- 1} \frac{{Δφ}_{u l}}{k r} \qquad ( 1 )$$

The direction θ₁ of the relay apparatus 20(1) viewed from the antenna element 112U at the upper part is expressed by the following equation (2). Herein, Api is the reception phase difference between the two antenna elements of the antenna element 112U of the upper part.

$${θ}_{1} = {sin}^{- 1} \frac{{Δφ}_{1}}{k r} \qquad ( 2 )$$

Further, the distance between the antenna element 112U at the upper part and the relay apparatus 20(1) is expressed by the following equation (3). Herein, Ao is the reception phase difference between antenna elements between the antenna element 112C at the center part and the antenna element 112U at the upper part.

$$D + \frac{Δφ}{k} \qquad ( 3 )$$

Since the shortest distance D′ between the virtual antenna surface along the surface of the main body of the antenna apparatus 110 and the relay apparatus 20(1) is expressed by the following equation (4), the distance D between the center of the antenna apparatus 110 of the base station 10 and the relay apparatus 20(1), which is finally determined, can be calculated and estimated using the following equation (5).

$${D}^{′} = D cos {θ}_{ul} = ( D + \frac{Δφ}{k} ) cos {θ}_{1} \qquad ( 4 )$$

$$D = \frac{Δφcos {θ}_{1}}{k ( cos {θ}_{ul} - cos {θ}_{1} )} \qquad ( 5 )$$

The positions (direction θ, distance D) of the other relay apparatuses 20(2) and 20(3) viewed from the center of the antenna apparatus 110 of the base station 10 can also be calculated and estimated in the same way.

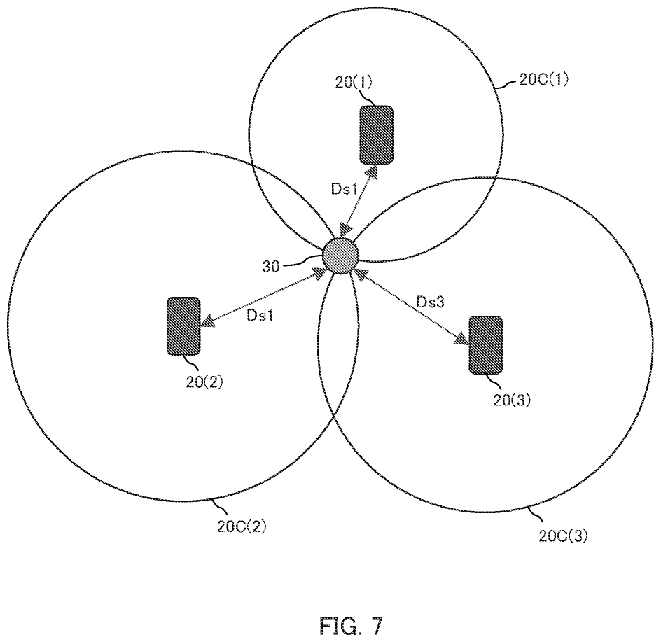

FIG. 7 is an illustration showing an example of a position estimation of the target apparatus 30 via the plural relay apparatuses 20(1) to 20(3) in the system according to the present embodiment. In FIG. 7, the positions of the relay apparatuses 20(1) to 20(3) are known through the above-described position estimation or the like. Each of the relay apparatuses 20(1) to 20(3) can work out by calculating distances Ds1 to Ds3 between each of the relay apparatuses 20(1) to 20(3) and the target apparatus 30, based on the received signal strength indicator (RSSI) of the predetermined signal received from the target apparatus 30 or the received signal strength indicator (RSSI) of the predetermined signal transmitted to the target apparatus 30 and received by the target apparatus 30. Furthermore, in a predetermined coordinate system, it is possible to uniquely calculate and estimate the coordinates of the intersection of virtual circles 20C(1) to 20C(3) centered on each of the relay apparatuses 20(1) to 20(3) and with radiuses of distances Ds1 to Ds3, as the position of the target apparatus 30.

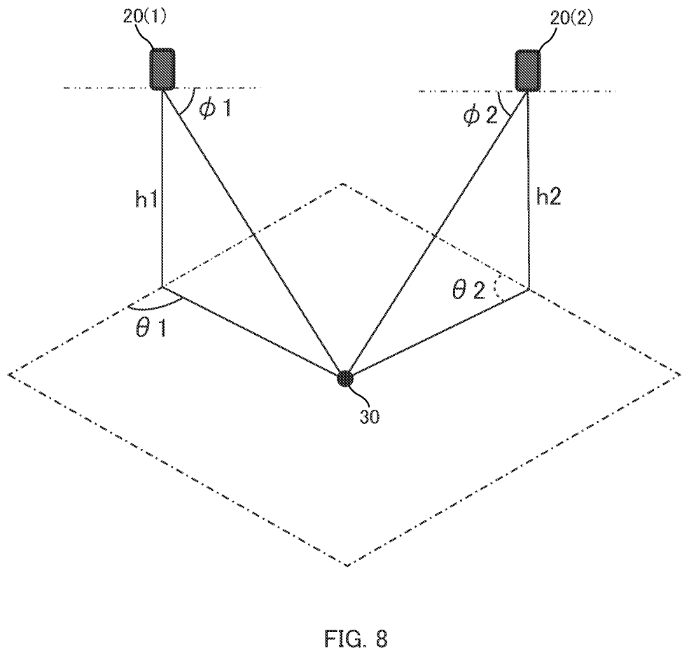

FIG. 8 is an illustration showing another example of a position estimation of the target apparatus 30 via plural relay apparatuses in the system according to the present embodiment. The example in FIG. 8 is an example of an angular-measurement-type position estimation method that uses only the angle-of-arrival (AoA) detection of radio waves. In FIG. 8, each of the plural relay apparatuses 20(1) and 20(2) receives radio waves transmitted from the target apparatus 30, and can calculate angles (φ1, θ1, φ1, θ2) of the direction of the target apparatus 30 viewed from each of the relay apparatuses 20(1) and 20(2) based on the reception results and the heights (h1, h2) of each of the relay apparatuses 20(1) and 20(2). The position coordinates of the target apparatus 30 can be calculated and estimated based on the calculation results of the angles (φ1, θ1, φ2, θ2).

It is noted that, in the example of FIG. 8, although the reception results of the two relay apparatuses 20(1) and 20(2) are used, the reception results of three or more relay apparatuses 20 may be used.

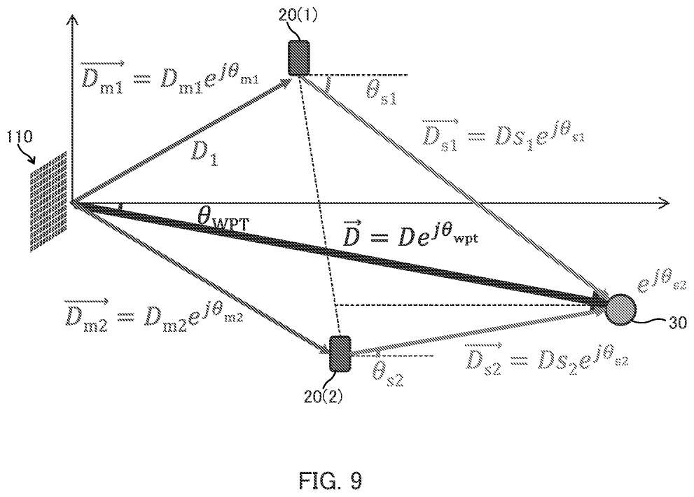

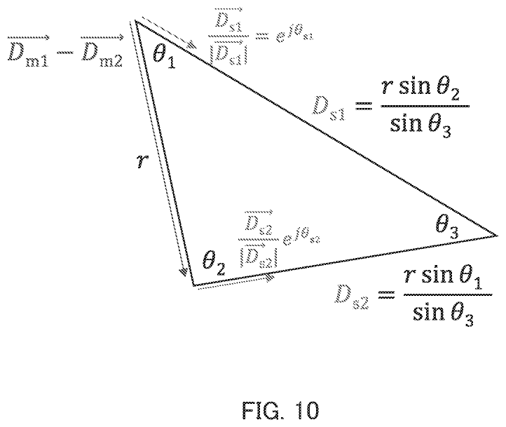

FIG. 9 is an illustration showing an example of an estimation model expressed using a complex vector used for the position estimation of the target apparatus 30 in the system according to the present embodiment. FIG. 10 is an illustration showing an example of estimation of the unknown quantities Ds1 and Ds2 in the estimation model of FIG. 9. FIGS. 9 and 10 shows an example of an angular-measurement-type position estimation model in the case of two-dimensional space.

In FIG. 9, each of the vectors Dₘ₁ and Dₘ₂ directed from the antenna apparatus 110 of the base station 10 to each of the plural relay apparatuses 20(1) and 20(2) is expressed by the following equations (6) and (7), and can be estimated by the AoA detection method in the near field describe above.

$$\vec{{D}_{m 1}} = {D}_{m 1} {e}^{j {θ}_{m 1}} \qquad ( 6 )$$

$$\vec{{D}_{m2}} = {D}_{m 2} {e}^{j {θ}_{m 2}} \qquad ( 7 )$$

Each of the angles θₛ₁ and θₛ₂ of directions in which the target apparatus 30 is viewed from each of the plural relay apparatuses 20(1) and 20(2) can be estimated by the above-described AoA detection method between the relay apparatuses 20(1) and 20(2) and the target apparatus 30.

The vector D directed from the antenna apparatus 110 of the base station 10 toward the target apparatus 30 is expressed by the following equation (8). Herein, Dₛ₁ and Dₛ₂ in the equation (8) are unknown quantities.

$$\begin{matrix}\vec{D} = D {e}^{j {θ}_{WPT}} = {D}_{m 1} {e}^{j {θ}_{m 1}} + {D}_{s 1} {e}^{j {θ}_{s 1}} \\ = {D}_{m 2} {e}^{j {θ}_{m 2}} + {D}_{s 2} {e}^{j {θ}_{s 2}}\end{matrix} \qquad ( 8 )$$

In FIG. 10, using the vectors Dₘ₁ and Dₘ₂ and the angles θₛ₁ and θₛ₂ described above, each of the angles θ₁, θ₂ and θ₃ is expressed by the following equations (9), (10) and (11).

$$cos {θ}_{1} = \frac{( \vec{{D}_{m 1}} - \vec{{D}_{m 2}} ) \cdot \frac{\vec{{D}_{s 1}}}{\vert \vec{{D}_{s 1}} \vert}}{\vert \vec{{D}_{m 1}} - \vec{{D}_{m 2}} \vert \cdot \vert \frac{\vec{{D}_{s 1}}}{\vec{\vert {D}_{s 1} \vert}} \vert} = \frac{{D}_{m 1} {e}^{j {θ}_{m {1}_{+}} {θ}_{s 1}} - {D}_{m 2} {{e}^{j {θ}_{m 2}}}^{+ {θ}_{s 1}}}{r} \qquad ( 9 )$$

$$cos {θ}_{2} = \frac{{D}_{m 2} {{e}^{j {θ}_{m {1}_{+}}}}^{{θ}_{s 1}} - {D}_{m 1} {{e}^{j {θ}_{m {2}_{+}}}}^{{θ}_{s 1}}}{r} \qquad ( 10 )$$

$${θ}_{3} = {{θ}_{s 1}}_{+} {θ}_{s 2} \qquad ( 11 )$$

Using the above-described equations (9) to (11), the foregoing unknown quantities Dₛ₁ and Dₛ₂ in the equation (8) are expressed by the following equations (12) and (13).

$${D}_{s 1} = \frac{r sin {θ}_{2}}{sin {θ}_{3}} \qquad ( 12 )$$

$${D}_{s 2} = \frac{r sin {θ}_{1}}{sin {θ}_{3}} \qquad ( 13 )$$

By applying the Dₛ₁ and Dₛ₂ obtained from these equations (12) and (13) to the equation (8) described above, it is possible to calculate and estimate the vector D (direction and distance) directed from the antenna apparatus 110 of the base station 10 toward the target apparatus 30.

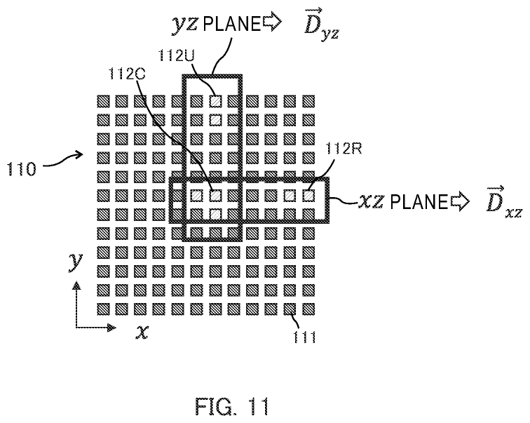

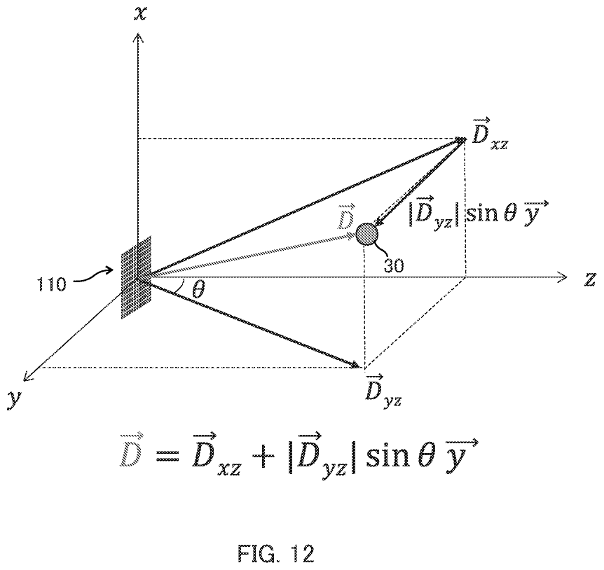

FIG. 11 is an illustration showing an example of definition of coordinates and planes in the position estimation of the target apparatus 30 in a three-dimensional space. FIG. 12 is an illustration showing an example of a position estimation of the target apparatus 30 in the three-dimensional space. As shown in FIG. 11, in a yz plane defined in the antenna apparatus 110 of the base station 10, a vector D_{yz} (direction and distance) directed from the antenna apparatus 110 toward the target apparatus 30 is calculated. Furthermore, in an xz plane defined in the antenna apparatus 110 of the base station 10, a vector D_{xz} (direction and distance) directed from the antenna apparatus 110 toward the target apparatus 30 is calculated. By using these two vectors D_{yz} and D_{xz}, the position (direction and distance) of the target apparatus 30 with respect to the target apparatus 30 in three-dimensional space can be calculated and specified as shown in FIG. 12 and the following equation (14).

$$\vec{D} = {\vec{D}}_{xz} + \vert {\vec{D}}_{y z} \vert sin θ \vec{y} \qquad ( 14 )$$

As described above, according to the present embodiment, by cooperating between the base station connected to the communication network and the relay apparatus that relays wireless communications with the target apparatus (IoT device) for a wireless power transfer, etc., it is possible to estimate the position of the target apparatus with high accuracy. Furthermore, it is possible to efficiently supply an electrical power to the target apparatus by directing the beam for wireless power transfer toward the target apparatus whose position is estimated.

It is noted that, the process steps and configuration elements of the wireless-power transfer apparatus, base station, relay apparatus, target apparatus, communication system and wireless-power transfer system described in the present description can be implemented with various means. For example, these process steps and configuration elements may be implemented with hardware, firmware, software, or a combination thereof.

With respect to hardware implementation, means such as processing units or the like used for establishing the foregoing steps and configuration elements in entities (for example, various kinds of wireless communication apparatuses, base station apparatus (Node B, Node G), terminal apparatus, hard disk drive apparatus, or optical disk drive apparatus) may be implemented in one or more of an application-specific IC (ASIC), a digital signal processor (DSP), a digital signal processing apparatus (DSPD), a programmable logic device (PLD), a field programmable gate array (FPGA), a processor, a controller, a microcontroller, a microprocessor, an electronic device, other electronic unit, computer, or a combination thereof, which are designed so as to perform a function described in the present specification.

With respect to the firmware and/or software implementation, means such as processing units or the like used for establishing the foregoing configuration elements may be implemented with a program (for example, code such as procedure, function, module, instruction, etc.) for performing a function described in the present specification. In general, any computer/processor readable medium of materializing the code of firmware and/or software may be used for implementation of means such as processing units and so on for establishing the foregoing steps and configuration elements described in the present specification. For example, in a control apparatus, the firmware and/or software code may be stored in a memory and executed by a computer or processor. The memory may be implemented within the computer or processor, or outside the processor. Further, the firmware and/or software code may be stored in, for example, a medium capable being read by a computer or processor, such as a random-access memory (RAM), a read-only memory (ROM), a non-volatility random-access memory (NVRAM), a programmable read-only memory (PROM), an electrically erasable PROM (EEPROM), a FLASH memory, a floppy (registered trademark) disk, a compact disk (CD), a digital versatile disk (DVD), a magnetic or optical data storage unit, or the like. The code may be executed by one or more of computers and processors, and a certain aspect of functionalities described in the present specification may by executed by a computer or processor.

The medium may be a non-transitory recording medium. Further, the code of the program may be executable by being read by a computer, a processor, or another device or an apparatus machine, and the format is not limited to a specific format. For example, the code of the program may be any of a source code, an object code, and a binary code, and may be a mixture of two or more of those codes.

The description of embodiments disclosed in the present specification is provided so that the present disclosures can be produced or used by those skilled in the art. Various modifications of the present disclosures are readily apparent to those skilled in the art and general principles defined in the present specification can be applied to other variations without departing from the spirit and scope of the present disclosures. Therefore, the present disclosures should not be limited to examples and designs described in the present specification and should be recognized to be in the broadest scope corresponding to principles and novel features disclosed in the present specification.

### REFERENCE SIGNS LIST

10: base station AP
10A: communication area (WPT area)
10B: beam
12P: path of radio wave for position measurement
20: relay apparatus
20(1): access point apparatus
20(2): access point apparatus
20(3): terminal apparatus (master repeater) of mobile communication system
23P: path of radio wave for position measurement
30: target apparatus (slave repeater, IoT device)
40: cloud computer system
100: base station apparatus
110: antenna apparatus (array antenna)
111: antenna element for wireless power transfer (WPT)
112: antenna element for phase measurement
210: antenna
220: antenna
310: antenna
311: antenna element

1. A method for estimating a position of an apparatus, comprising:
receiving near-field radio waves from a relay apparatus positioned in an area between a base station and a target apparatus by plural antenna elements of an antenna apparatus of the base station;
calculating, for each of the plural antenna elements, an angle of a direction of the relay apparatus with respect to a position of the antenna element based on a reception result of the radio waves from the relay apparatus; and
estimating a position of the relay apparatus based on a calculation result of the angle of each of the plural antenna elements and position information on the antenna element in the antenna apparatus.

2. The method according to claim 1, comprising:
receiving the radio waves from the target apparatus by plural relay apparatuses whose positions are estimated;
calculating, for each of the plural relay apparatuses, angle information on the direction of the target apparatus or distance information on the target apparatus with respect to the position of the relay apparatus based on a reception result of the radio waves from the target apparatus; and
estimating the position of the target apparatus based on a calculation result of the angle information or the distance information on each of the plural relay apparatuses and position information on each of the plural relay apparatuses.

3. A wireless-power transfer method, comprising:
forming a beam toward the target apparatus based on the estimation result of the position of the relay apparatus and the estimation result of the position of the target apparatus estimated by the method according to claim 2, and transmitting an electrical power to the target apparatus via the beam, by the base station.

4. The wireless-power transfer method according to claim 3, comprising
determining a tilt angle of the beam toward the target apparatus based on the estimation result of the position of the relay apparatus and the estimation result of the position of the target apparatus.

5. A system comprising a base station connected to a communication network, the system comprising a relay apparatus positioned in an area between the base station and a target apparatus, and
wherein the base station:
receives near-field radio waves from the relay apparatus by plural antenna elements of an antenna apparatus;
calculates, for each of the plural antenna elements, an angle of a direction of the relay apparatus with respect to a position of the antenna element based on a reception result of the radio waves from the relay apparatus; and
estimates a position of the relay apparatus based on a calculation result of the angle of each of the plural antenna elements and position information on the antenna element in the antenna apparatus.

6. The system according to claim 5, comprising plural relay apparatuses, and
wherein each of the plural relay apparatuses:
receives the radio waves from the target apparatus;
calculates angle information on the direction of the target apparatus or distance information on the target apparatus with respect to the position of the relay apparatus based on a reception result of the radio waves from the target apparatus; and
transmits a calculation result of the angle information or the distance information to the base station, and
wherein the base station:
estimates the position of the target apparatus based on the calculation result of the angle information or the distance information on each of the plural relay apparatuses and position information on each of the plural relay apparatuses.

7. The system according to claim to 5, comprising plural relay apparatuses, and
wherein each of the plural relay apparatuses:
receives the radio waves from the target apparatus; and
transmits a reception result of the radio waves from the target apparatus to the base station, and
wherein the base station:
calculates, for each of the plural relay apparatuses, angle information on the direction of the target apparatus or distance information on the target apparatus with respect to a position of the relay apparatus based on a reception result of the radio waves from the target apparatus; and
estimates a position of the target apparatus based on the calculation result of the angle information or the distance information on each of the plural relay apparatuses and position information on each of the plural relay apparatuses.

8. The system according to claim 6,
wherein the base station forms a beam toward the target apparatus based on the estimation results of the positions of the plural relay apparatuses and the estimation result of the position of the target apparatus, and wirelessly transmits an electrical power to the target apparatus via the beam.

9. The system according to claim 8,
wherein the base station determines a tilt angle of the beam toward the target apparatus based on the estimation results of the positions of the relay apparatuses and the estimation result of the position of the target apparatus.

10. A base station that is provided in the system according to claim 5, the base station comprising:
means for receiving near-field radio waves from the relay apparatus by plural antenna elements of the antenna apparatus;
means for calculating, for each of the plural antenna elements, an angle of a direction of the relay apparatus with respect to a position of the antenna element based on a reception result of the radio waves from the relay apparatus; and
means for estimating a position of the relay apparatus based on a calculation result of the angle of each of the plural antenna elements and position information on the antenna element in the antenna apparatus.

11. The base station according to claim 10, comprising:
means for forming a beam toward the target apparatus based on the estimation results of the positions of the plural relay apparatuses and the estimation result of the position of the target apparatus, and wirelessly transmitting an electrical power to the target apparatus via the beam.

12. The base station according to claim 11, comprising:
means for determining a tilt angle of the beam toward the target apparatus based on the estimation results of the positions of the relay apparatuses and the estimation result of the position of the target apparatus.

13. The base station according to claim 10,
wherein the base station is a base station of a mobile communication system that has a wireless-power transfer function to the target apparatus.

14. The base station according to claim 10,
wherein the antenna apparatus is an array antenna in which plural antenna elements are disposed two-dimensionally or three-dimensionally.

15. The base station according to claim 14,
wherein the antenna apparatus comprises antenna elements for position measurement, the antenna elements being spaced apart from each other and used for estimating the position of the relay apparatus.

16. A relay apparatus that is provided in the system according to claim 6, the relay apparatus comprising:
means for receiving the radio waves from the target apparatus;
means for calculating angle information on a direction of the target apparatus or distance information on the target apparatus with respect to a position of the relay apparatus based on a reception result of the radio waves from the target apparatus; and
means for transmitting a calculation result of the angle information or the distance information to the base station.

17. A relay apparatus that is provided in the system according to claim 7, the relay apparatus comprising:
means for receiving the radio waves from the target apparatus; and
means for transmitting a reception result of the radio waves from the target apparatus to the base station.

18. The relay apparatus according to claim 16,
wherein the relay apparatus is a terminal apparatus of a mobile communication system or an access point apparatus.

19. A non-transitory computer readable medium containing software that is executed by a computer or processor provided in the base station according to claim 10, the software comprising:
executable code that receives near-field radio waves from the relay apparatus by plural antenna elements of the antenna apparatus;
executable code that calculates, for each of the plural antenna elements, an angle of a direction of the relay apparatus with respect to a position of the antenna element based on a reception result of the radio waves from the relay apparatus; and
executable code that estimates a position of the relay apparatus based on a calculation result of the angle of each of the plural antenna elements and position information on the antenna element in the antenna apparatus.

20. A non-transitory computer readable medium containing software that is executed by a computer or processor provided in the relay apparatus according to claim 16, the software comprising:
executable code that receives the radio waves from the target apparatus;
executable code that calculates angle information on a direction of the target apparatus or distance information on the target apparatus with respect to a position of the relay apparatus based on a reception result of the radio waves from the target apparatus; and
executable code that transmits a calculation result of the angle information or the distance information to the base station.

21. A non-transitory computer readable medium containing software that is executed by a computer or processor provided in the relay apparatus according to claim 17, the software comprising:
executable code that receives the radio waves from the target apparatus; and
executable code that transmits a reception result of the radio waves from the target apparatus to the base station.

22. The system according to claim 7,
wherein the base station forms a beam toward the target apparatus based on the estimation results of the positions of the plural relay apparatuses and the estimation result of the position of the target apparatus, and wirelessly transmits an electrical power to the target apparatus via the beam.

23. The system according to claim 22,
wherein the base station determines a tilt angle of the beam toward the target apparatus based on the estimation results of the positions of the relay apparatuses and the estimation result of the position of the target apparatus.

24. The relay apparatus according to claim 17,
wherein the relay apparatus is a terminal apparatus of a mobile communication system or an access point apparatus.
